(19) United States
(12) Patent Application Publication
(10) Pub. No.: US 2005/0289236 A1
(43) Pub. Date: Dec. 29, 2005

(54) Method and server for establishing coordinated consumption of a streamed media object by multiple devices

(76) Inventors: Richard Hull, Bristol (GB); Josephine Reid, Bristol (GB); Stuart Philip Stenton, Gloucestershire (GB)

Correspondence Address: HEWLETT-PACKARD COMPANY;Intellectual Property Administration, P.O. Box 27240, Fort Collins, CO, 80527-2400, US

(21) Appl. No.: 10/635,941

(22) Filed: Aug. 5, 2003

(30) Foreign Application Priority Data
Aug. 6, 2002 (GB) 0218188.1
Oct. 18, 2002 (GB) 0223135.5

(51) Int. Cl. G06F 15/16

(52) U.S. Cl. 709/231

(57) ABSTRACT

For members of a party visiting a space with which media objects are associated, the shared experience can be enhanced by the sharing of such objects by the group members for presentation on devices for example carried by the group members. Where the media object is a streamed media object, the experience can be further enhanced by coordinating the consumption of the object by the group members. To this end, a server streaming the media object to a first device is arranged to respond to a request for coordinated consumption by establishing streaming of the object to a second device starting from a position in the media object that is dependent on progress of the streaming/presentation of the object to/at the first device.

### FIELD OF THE INVENTION

The present invention relates to a method and server for establishing the coordinated consumption of a streamed media object by multiple devices.

### BACKGROUND OF THE INVENTION

For members of a party visiting a space with which media objects are associated, the shared experience can be enhanced by the sharing of such objects by the group members for presentation on mobile devices carried by the group members. Conventionally, media objects are shared by reference, for example by passing an appropriate URI. Where the media object is a streamed object, a recipient using a shared reference to the media object will typically experience the streamed media object from its beginning, whilst the person who passed on the reference will already be some way through the streamed object. However, the person who passed on the reference may wish the recipient of the reference to experience the media object in a synchronized manner, i.e. to ensure that they both experience the same parts of the media stream in the same order and at the same time. Colloquially, one person wishes to invite the second person to “listen to this” (or “look at this” etc). Multicast streaming protocols are known which enable a single media stream to be sent to multiple devices over the Internet with synchronization of multiple media channels within a composite, structured media stream (e.g. SMIL). However such protocols are not widely deployed in the internet.

It is an object of the present invention to provide a way of establishing coordinated presentation of a streamed media object on multiple devices without the use of multicasting protocols.

### SUMMARY OF THE INVENTION

According to one aspect of the present invention, there is provided a method of establishing coordinated consumption of a streamed media object by first and second devices, comprising the steps of:
(a) in the course of streaming the media object in a first stream from a server to the first device and presenting the object thereat, using a said device to effect initiation of said coordinated consumption;
(b) consequent on said initiation, establishing streaming of the media object from the server to the second device in a second stream separate from said first stream and starting from a position in the media object that is dependent on progress of the streaming/presentation of the object to/at the first device; and
(c) presenting the media object at the second device.

According to another aspect of the present invention, there is provided a server for use in establishing coordinated consumption of a streamed media object by first and second devices, the server comprising:
a first entity for streaming the media object to the first device in a first stream;
a second entity for streaming the media object to the second device in a second stream separate from said first stream; and
a control arrangement arranged to receive an indication, in the course of the first entity streaming the media object to the first device in said first stream, that coordinated consumption of the media object by the first and second devices is to be established; the control arrangement being further arranged, in response to receipt of said indication, to cause the second entity to establish streaming of the media object to the second device in said second stream starting from a position in the media object that is dependent on progress of the streaming/presentation of the object to/at the first device.

According to another aspect of the present invention, there is provided a method of coordinated consumption of a streamed media object by first and second devices, the media object being accessible for streaming from a server, the method comprising the steps of:
(a) streaming the media object from the server to the first device and presenting it to a user of this device;
(b) sending from the first device to the second device, during the course of step (a), data identifying the media object and a current position reached in presenting the object to the user of the first device;
(c) in response to a request from the second device, streaming the media object from the server to the second device in a separate stream to that involving the first device with the second stream starting from a position in the media object that is at or near the current position reached by the first device in presenting the media object; and
(d) presenting the media object to the user of the second device such that normal presentation commences at a position at, or with an advance relative to, the said current position indicated in step (b).

### BRIEF DESCRIPTION OF THE DRAWINGS

Embodiments of the invention will now be described, by way of non-limiting example, with reference to the accompanying diagrammatic drawings, in which:

FIG. 1 is a diagram of an exhibition hall having an arrangement for delivering relevant media objects to visitors in a tinely manner as the visitors encounter items of interest in the hall;

FIG. 2 is a diagram of a mobile device and service system used in the FIG. 1 arrangement;

FIG. 3 is a diagram of a location report sent from the mobile device to the service system of FIG. 2;

FIG. 4 is a diagram of a response message sent by the service system to the mobile device of FIG. 2; and

FIG. 5 is a diagram illustrating coordinated consumption of a streaming media by two devices.

### BEST MODE OF CARRYING OUT THE INVENTION

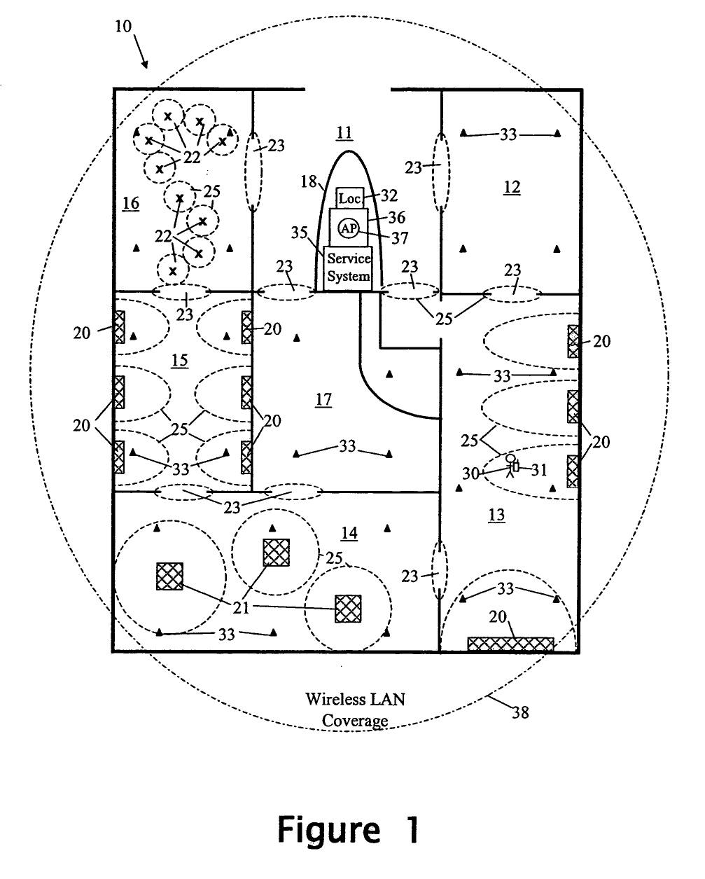

FIG. 1 depicts a real-world environment for which a number of zones have been defined in a virtual world that maps onto the environment. When a person moving in the environment (called a “user” below) is detected as moving into one of these zones, one or more media objects are delivered to the user via a communications infrastructure and a mobile device carried by the user. A zone may correspond to an area around a real-world object of interest with the media object(s) delivered to a user in this area relating to that real-world object. Alternatively, a zone may not correspond to any real-world object.

In considering such an arrangement, it is convenient, though not essential, to introduce the abstraction of a virtual feature which is the subject of each zone. Each such virtual feature is given a number of properties such as a unique identifier, a location in the real-world environment, the real-world extent of the zone associated with the feature, a subject description indicating what the feature concerns, and a set of one or more media-object identifiers identifying the media objects (or “feature items”) associated with the feature. The zone associated with a virtual feature is referred to hereinafter as the ‘active zone’ of the feature.

For a feature that is intended to correspond to a particular real-world item (and typically having an active zone that maps to an area about a real-world object), this can be indicated in the subject description of the feature. Using the feature abstraction makes it easier to associate feature items that all relate to the same zone and also facilitates adding/removing these features items since data about the real-world extent of the related zone is kept with the feature and not each feature item.

Each feature is represented by a feature record held in a data-handling system, the feature records together defining the aforesaid virtual world that maps to the real-world environment. Each feature can be thought of as existing in this virtual world with some of these virtual features mapping to real-world objects.

As already noted, when a user is detected as within an active zone of a feature, one or more feature items are delivered to the mobile device of the user for presentation to the user. A feature item can be presented automatically to the user upon delivery or the item can be cached and only presented upon the user having expressed an interest in the feature in some way such as by dwelling in the active zone of the feature more than a minimum time or by explicitly requesting presentation of the feature item. Indeed, the delivery of the feature item to the mobile device can also be deferred until the user is detected as having expressed an interest in the feature; however, since this approach can introduce a delay before the item is available for presentation, the embodiments described below deliver feature items to the mobile device of the user without awaiting a specific expression of interest in each feature (though, of course, a general filtering may be applied as to what items are delivered according what types of features are of interest to the user). Preferably, each feature or feature item is given a property indicating whether feature item delivery is to be effected automatically upon delivery or only after a user has expressed an interest in the feature; this enables important items (such as warning messages concerning features associated with potentially hazardous real-world items) to be pushed to the user whilst other items are subject to an expression of interest by the user. Advantageously, a user may elect to have feature items automatically presented even when the corresponding feature/item property does not require this. Furthermore, since as will be described hereinafter, pre-emptive caching of feature items in the user's mobile device may be implemented, automatic presentation is qualified so as only to apply where the user is in the active zone of the feature with which the feature item is associated.

Considering the FIG. 1 example in more detail, the environment depicted is an exhibition hall 10 having rooms 11 to 17 where:
room 11 is an entrance foyer with reception desk 18 but no associated virtual features;
room 12 is a reference library with no associated virtual features;
rooms 13, 14 and 15 are used for displaying real-world objects, namely paintings 20 and sculptures 21, for each of which there is a corresponding virtual feature centred on the object concerned and with an associated active zone 25 (indicated by a dashed line);
room 16 is used for experiencing virtual features for which there are no corresponding real-world objects, the location associated with each feature being indicated by a cross 22 and the corresponding active zone 25 by a dashed line; and
room 17 is a cafeteria with no associated virtual features.

Virtual features are also defined in correspondence to the majority of openings 23 between rooms, the active zones 25 associated with the features again been indicated by dashed lines. Typically, the feature items associated with these features are incidental information concerning the room about to be entered and are automatically presented. It will be seen from FIG. 1 that only a single feature is applied to an opening 23 so that it is not possible to tell simply from the fact that a user is detected in the active zone of the feature which room the user is about to enter; however, as will be later described, it is possible to determine from the user's past activity (either location based or feature based) the general direction of progression of the user and therefore which room is about to be entered. This enables the appropriate feature item to be selected for delivery to the user from amongst the items associated with the feature.

On entering the exhibition hall 10, a user 30 collects a mobile device 31 from the reception desk 18 (or the user may have their own device). This device 31 cooperates with location-related infrastructure to permit the location of the user in the hall 10 to be determined. A number of techniques exist for enabling the location of the user to be determined with reasonable accuracy and any such technique can be used; in the present example, the technique used is based on an array of ultrasonic emitters 33 (represented in FIG. 1 by black triangles) positioned at known locations in each room (typically suspended above human level). The emitters 33 are controlled by controller 32 to send out emitter-specific emissions at timing reference points that are indicated to the mobile device 31 by a corresponding radio signal sent by the controller 32. The device 31 is capable of receiving both the timing reference signals and the emissions from the ultrasonic transmitters 33. The device 31 is also pre-programmed with the locations of these emitters and is therefore able to calculate its current location on the basis of the time of receipt of the emissions from the different emitters relative to the timing reference points.

The exhibition hall is equipped with a wireless LAN infrastructure 36 comprising a distribution system and access points 37. The wireless LAN has a coverage encompassing substantially all of the hall 10, the boundary of the coverage being indicated by chain-dashed line 38 in FIG. 1. The wireless LAN enables the mobile device to communicate with a service system 35 to download feature items appropriate to the feature (if any) corresponding to the current location of the user. In the present example, the determination of when the location of the user (as determined by the device in the manner already described) places the user within the active zone of a virtual feature, is effected by the service system; however, it is also possible to have the device 31 carry out this determination provided it is supplied with the appropriate information about the feature zones.

It will be appreciated that communication between the device 31 and service system 35 can be effected by any suitable means and is not limited to being a wireless LAN.

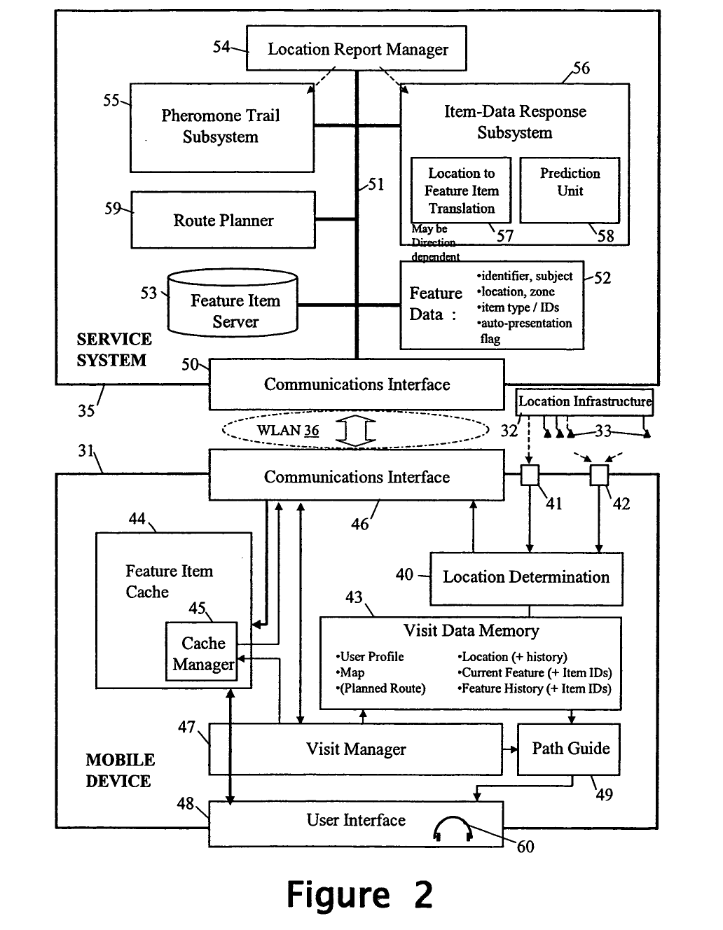

FIG. 2 shows the mobile device 31 and service system 35 in more detail. More particularly, the mobile device 31 comprises the following functional blocks:
A location determination subsystem 40 with an associated timing reference receiver 41 and ultrasonic receiver 42 for receiving the timing reference signals from the location infrastructure 32 and the emissions from the ultrasonic emitters 33 respectively; the location determination subsystem 40 is operative to use the outputs of the receivers 41 and 42 to determine the location of the mobile device (as already described above) and to send location reports to the service system 35.
A visit data memory 43 for holding data about the current “visit”—that is, the current tour of the hall 10 being undertaken by the user of the mobile device 31.
A feature-item cache 44 for caching feature items delivered to the mobile device 31 from the service system 35. The cache 44 has an associated cache manager 45.
A communications interface 46 for enabling communication between the mobile device 31 and the service system 35 via the wireless LAN infrastructure 36.
A user interface 48 which may be visual and/or sound based; in one preferred embodiment the output to the user is via stereo headphones 60.
A visit manager 47 typically in the form of a software application for providing control and coordination of the other functions of the mobile device 31 in accordance with input from the user and the service system 35.
A visit path guide 49 for giving the user instructions/indicators for following a planned route around the hall 10.

Much of the foregoing functionality will typically be provided by a program-controlled general purpose processor though other implementations are, of course, possible.

The visit data held by memory 44 will typically include a user/device profile data (for example, indicating the subjects of interest to the user, the intended visit duration, and the media types that can be handled by the device), an electronic map of the hall 10, the user's current location as determined by the subsystem 40, and the identity of the feature (if any) currently being visited together with the IDs of its related feature items. The visit data also includes a feature history for the visit, which is either:
the history of visited features and their related feature item IDs in the order the features were visited (thus, a feature is added to the top of the visited-feature history list when the feature is encountered), or
the history of accessed features and their related feature item IDs in the order the features were visited (thus, a feature is added to the top of the accessed-feature history list when one of its feature items is accessed by—that is, presented to—the user whilst the feature is the currently visited feature).

If a visited-feature history list is kept, a history of accessed features can be embedded in it by providing each feature in the history with an associated flag to indicate whether or not the feature was accessed whilst current. Although keeping a visited-feature history provides more information about the visit, it will inevitably use more memory resources than an accessed-feature history and in many cases it will only be desired to track features which the user has found sufficiently of interest to access an associated feature item. Where the purpose of the feature history is simply to keep a list of features (and related feature items) that were of interest to the user, it may be desirable to exclude from the list features for which items were automatically presented but are not associated with exhibits (real or virtual)—that is, exclude features concerned with incidental information about the hall.

The feature history preferably covers the whole of the visit though it may alternatively only cover the most recently visited/accessed features. In either case, the most recent several entries in the history list form what is hereinafter referred to as the “feature tail” of the user and provides useful information about the path being taken by the user.

The visit data held in memory 43 may further include details of a planned route being followed by the user, and a history of the locations visited by the user (this may be a full history or just the locations most recently visited—hereinafter termed the “location tail” of the user).

The service system 35 comprises the following main functional elements:
A communications interface 50 for communicating with the mobile device 50 via the wireless LAN infrastructure 36.
An internal LAN 51 (or other interconnect arrangement) for interconnecting the functional elements of the service system.
A data store 52 for storing feature data and, in particular, a feature record for each feature with each record comprising the feature identifier, the subject of the feature, the corresponding real-world location and extent of the feature's active zone, the IDs and media type of the or each associated feature item, and a flag which when set indicates that feature item presentation of an associated feature item is to be effected automatically upon delivery when the feature is being visited.
A feature-item server 53 for serving an identified feature item to the mobile device 31 in response to a request from the latter.
A location report manager 54 for receiving location reports from the location determination subsystem 40 of the mobile device and for passing on data from the reports to functional elements 55 and 56 (see below).
A pheromone trial subsystem 55 for receiving location data, via manager 54, from all user mobile devices to build up trail data in a manner akin to the use of pheromones by ants.
An item-data response subsystem 56 for receiving location and other data from the manager 54 in order to prepare and send a response back to the mobile device 31 that provided the location data, about what feature items it needs, or is likely to need, both now, in view of a feature currently being visited, and (where, as in the present embodiment, pre-emptive caching is implemented) in the near future. Subsystem 56 comprises a location-to-feature item translation unit 57 which can either be implemented independently of the data held in store 52 or, preferably, be arranged to operate by querying the store 52, the latter having associated functionality for responding to such queries. Subsystem 56 further comprises a prediction unit 58 for predicting, in any of a variety of ways to be described hereinafter, what feature items are most likely to be needed in the near future.
A route planner 59 for responding to requests from the mobile device 31 for a route to follow to meet certain constraints supplied by the user (such as topics of interest, time available, person or tour to follow, an exhibit or facility to be visited, etc). In providing a planned route, the route planner will typically access data from one or both of the feature data store 52 and the pheromone trail subsystem 55. The route planner 59 can conveniently hold a master map of the hall 10 for use by itself and the other elements of the service system 35, and for download to each mobile device 31 at the start of each new visit and/or whenever the master map is changed.

The functional elements of the service system 35 can be configured as a set of servers all connected to the LAN 51 or be arranged in any other suitable manner as will be apparent to persons skilled.

The mobile device 31 and service system 35 provide a number of useful capabilities that will each be described in detail below after an overview of the general operation of the mobile device and service system during a visit. It is to be understood that the split of functionality between the mobile device 31 and service subsystem 35 can be varied substantially form that indicated for the FIG. 2 embodiment; indeed all functionality can be provided either entirely by the mobile device 31 (with all feature items being stored in the device) or by the service system 35 (with the presentation of feature items to a user being by means of fixed input/output devices located around the hall near the locations associated with the virtual features).

In general terms, a user starting a visit can request a route to follow using the user interface 48 of the mobile device 31 to indicate parameters to be satisfied by the route. This route request is sent by the visit manager to route planner 50 and results in the download to the mobile device 31 of a planned route. The path guide 49 then provides the user (typically, though not necessarily, only when asked) with guide indications to assist the user in following the planned route. Where the interface 48 includes a visual display, this can conveniently be done by displaying a map showing the user's current location and the planned route; in contrast, where only an audio interface is available, this can be done by audio cues to indicate the direction to follow. A user need not request a planned route and in this case will receive no guide indications. A user may request a route plan at any stage of a visit (for example a route to an exhibit of interest).

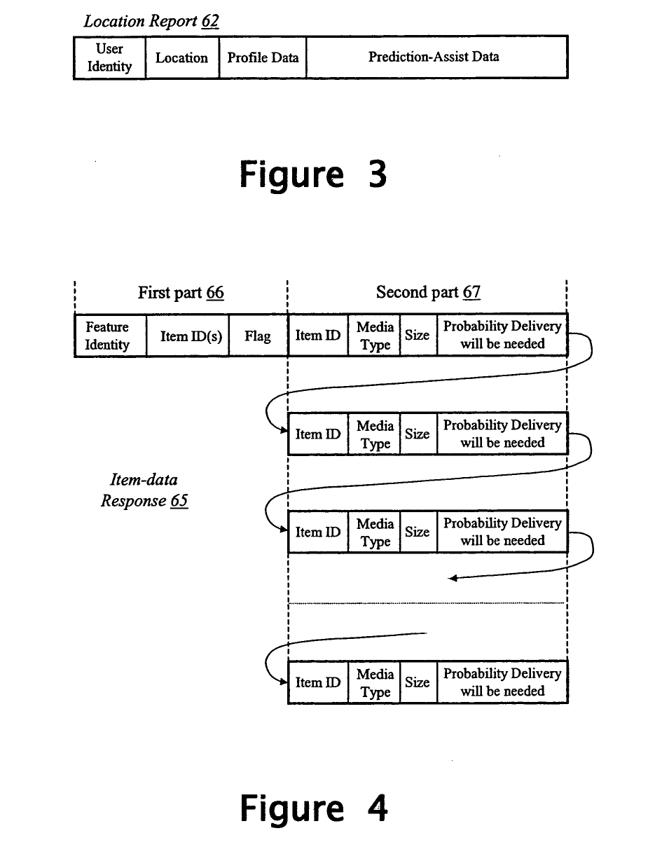

As the user moves through the hall, the location determination subsystem 40 sends periodic location reports 62 (see FIG. 3) to the location report manager 54 of the service system 35 via the wireless LAN 36. In addition to the user's current location, these reports typically include a user identifier (and possibly, additionally or alternatively, a type identifier indicative of any variable of interest such as, for example, the group of users to which the device user belongs or an activity being undertaken by the user), user/device profile data, and prediction-assist data for use by the prediction unit 58 in predicting what feature items are likely to be needed shortly. This prediction-assist data can comprise one or more of the following: route data concerning any planned route being followed; the user's “location tail”; and the most recent feature (either the “most-recently visited” or “most-recently accessed”) associated with the user, either provided alone or as part of the user's “feature tail”.

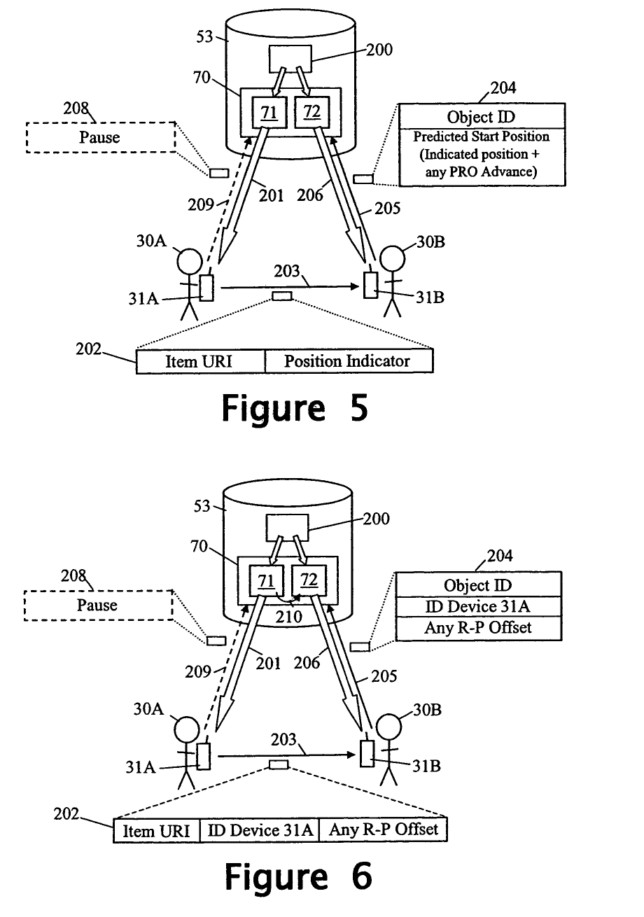

When a location report 62 is received by the manager 54, it passes on the user's current location in the report to the pheromone trail subsystem 55 to enable the latter to build up trail data from all devices; additionally, the user and/or type identifier may be passed on to subsystem 55 if provided in the location report. The user's current location is also passed to the item-data response subsystem 56 together with any profile data and prediction-assist data in the location report 62. The item-data response subsystem 56 then constructs and sends a response 65 (see FIG. 4) to the mobile device 31 that originated the location report.

More particularly, the location-item to feature translation unit 57 of subsystem 56 uses the data passed to subsystem to determine the feature, if any, currentlybeing visitedbythe user and thus what feature items are relevant to the user in their current location. In doing this, the unit 57 may also use the supplied profile data to disregard both features that do not relate to a subject of interest to the user and feature items of a media type that cannot be handled by the mobile device 31. The unit 57 may also use elements of the prediction-assist data (for example, the location or feature last encountered before the current one) to enable it to determine the direction of progression of the user and thus to select between feature items of a feature in dependence on the direction of approach of the user. This is done, for example, for the features associated with openings 25 in order to select a feature item appropriate to entering a room. The IDs of feature items identified by the unit 57 together with the identity of the corresponding feature and the status of the automatic presentation flag of the feature, form a first part 66 of the response 65 to be sent back to the mobile device 31. Where the current location does not correspond to the active zone of any feature, the first response part 66 simply indicates this.

A second part 67 of the item-data response 65 is produced by the prediction unit 58 and comprises a list of the feature items most likely to be needed in the near future by the mobile device 31; for each such feature item, the second response part 67 includes the feature ID, its type, size and probability of usage (discussed in detail hereinafter). Like the unit 57, the unit 58 uses supplied profile data to disregard feature items of features not of interest to the user or of a media type that cannot not be handled by the mobile device 31. The number of feature items identified in response part 67 is preferably limited (for example, to ten such items). The item-data response subsystem 56 then sends the response 65 back to the mobile device 31 of the user by using a return address supplied with the original location report 62 and passed to subsystem 56 by the manager 54.

Rather than having the prediction unit 58 provide a prediction each and every time the mobile device 31 sends a location report, it is possible to arrange for the prediction unit 58 only to operate when required by the mobile device 31 with the latter only requiring a prediction, for example, every nth location report or only after the user has moved a certain distance since the last prediction made by unit 58. Conveniently, the location report field used to carry the prediction-assist data is also used to indicate when a prediction is required by, for example, setting the field to a predetermined value when prediction is not required.

The item-data response received back at the mobile device 31 is processed by the visit manager 47. If the first part 66 of the response identifies a feature (thereby indicating that the current location of the user corresponds to the active zone of feature), the manager 47 updates the ‘current feature’ data in memory 45 to the feature identifier and item IDs in the first response part. These item IDs are also passed to the cache manager 45 and are used by the latter to request immediate delivery of these items from the server 53 of the service system to cache 44, if not already present in the cache. If the feature history data held by memory 43 relates to visited, rather than accessed, features, and ifthe feature identifier and item IDs in the first response part 66 differ from the most recent entry in the feature history list, the latter is updated with the feature identifier and item IDs from the first response part 66.

In the case that no feature is identified in the first part of the response 65, the ‘current feature’ data in memory 43 is set to null.

The manager 47 also determines whether the (first) feature item (if any) identified in the first response part 66 is to be immediately presented to the user, this determination taking account of the setting of the automatic presentation flag in the first part of the response, any user indication (stored, for example in the profile data) that all items are to be automatically presented, and any monitored indications of the user's interest in the currently-visited feature. Where a feature item identified in the first response part is to be immediately presented to the user, the manager 47 requests the item from the cache manager 45 (there may be a delay in the delivery of the item if it has not yet been received from the server 53). At the same time, if the feature history concerns accessed features the manager 47 updates the feature history with an entry corresponding to the feature identifier and item IDs forming the ‘current feature’ data; where the feature history although recording all visited features, provides for indicating whether a feature has been accessed, the manager updates the feature history accordingly.

With respect to the data contained in the second part 67 of the response 65, the visit manager simply passes this data to the cache manager 45 which determines whether or not to request from server 53 any of the items identified that are not already in the cache 44. The cache manger 47 in making this determination takes account of the probability that an item will be needed in the near future and the available cache space. The cache manager 45 may decide to create additional cache space by flushing one or more items from the cache and/or by reducing the space they occupy, as will be more fully described hereinafter.

In this manner, the cache manager 45 seeks to ensure that the next item requested by the visit manager 47 as the user progresses to the next feature will already be in the cache 44.

Following the processing of an item-data response by the visit manager, whenever a feature item is accessed (presented) either as a result of the visit manager 47 determining that the current feature is of interest to the user or as result of the user specifically requesting the item (for example, after inspecting the list of items associated with the current feature), then where the feature history data records accessed feature information, the visit manager 47 checks if the feature associated with the accessed item is the current feature and, if so, updates the feature history to record the feature as an accessed one if not already so indicated.

The visit manager can also be arranged to keep a list in memory 43 of the individual feature items accessed.

Having described the general operation of the mobile device 31 and service system 35, a more detailed description will now be given of some of the functionality embodied in the arrangement of FIGS. 1 and 2.

Coordinated Consumption

Often a user visiting the exhibition hall 10 will be doing so as a member of a party, be it a family group, a tour party or some other group. Where at least some members of the party have respective mobile devices, the situation is likely to arise that one member with a mobile device accesses a feature item that they then wish to share with the other party members with mobile devices; indeed, this may the case not only for feature items but for any data item available from the service system 35 or other source accessible via the communications infrastructure exemplified in the embodiment of FIGS. 1 and 2 by wireless LAN 36. Where the data item is a simple media object such as image, then this is can be achieved by the accessing member passing on the identity of the item to the other members either verbally or possibly by a message sent from their mobile device to the other mobile devices associated with the party.

However, where the item concerned is a streamed media object (in particular, audio and/or video streams), simply having each mobile device independently access the object will result in uncoordinated consumption of the object at each device.

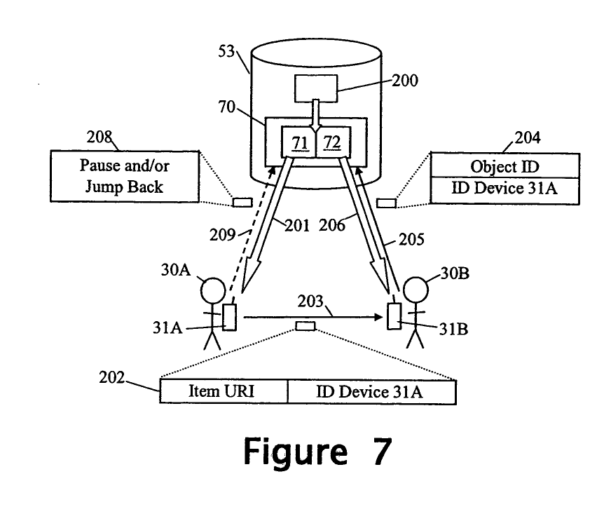

Three arrangements for providing for coordinated consumption of the streamed media object are described below with respect to FIGS. 5, 6 and 7 respectively. However, before preceding to the description of these arrangements, some of the issues involved will be discussed.

Coordinated consumption of a streamed media object on different devices implies coordinated presentation of the object on each device (in this context, “coordinated” is not intended to be restricted to precisely synchronized presentations and is intended to cover presentations that closely match each other). Since streamed media may be sent at a rate greater than its rate of consumption with the receiving device buffering the received but not yet consumed portions of the stream, there may be an offset at a receiving device between the current presentation position within the media object and the current receiving position within the same object (that is, the current position reached within the object as regards the most recently received media-object data at the device—typically, this will be closely similar to the current sending position reached by the media-object server in streaming the media object to the device). This offset between the receiving and presentation positions at the receiving device is referred to below as the “R-P offset”. The R-P offset will typically change (increase) during the course of the streaming of a media object though its size may be limited by the size of the cache provided at the device for buffering streamed objects.

Where the rate of sending of the streamed media object is, at least on average, matched to the rate of consumption of the object, the R-P offset will be non-existent or small.

A user using a device for the presentation of a media object which the user then decides should be shared with others by presentation on their individual devices, has a choice (at least in theory) regarding whether to continue with the user's own consumption of the media object or to pause this consumption whilst the other devices establish respective streams for the media object concerned. If the initiator of the coordinated consumption pauses media object consumption, the coordination task is simplified; however, if the initiator continues consumption of the media object, there will be a presentation run on between the presentation position reached when the initiator's device requests the other devices to effect coordinated consumption of the media object, and the presentation position reached by the time the other devices are ready to present the media object to their users. This presentation run on is referred to below as the “PRO advance.”

Considering first the arrangement of FIG. 5, this is based on the initiator device passing a position indicator giving its current presentation position for the media object concerned to a second device(s), and this device (or the media-object server) deriving a PRO advance to be used with the position indicator to determine the point within the media object at which the server should start streaming the object to the second device.

More particularly, in FIG. 5 a streamed media object 200 held on server 53 is depicted as being streamed (arrow 201) to the mobile device 31A of a first user 30A, this streaming being controlled by a stream delivery entity 71 of an interface unit 70 of the server. Upon the user 30A wished to share the experience provided by this media object with another user 30B, the user 30A causes the mobile device 31A (for example, by pressing a dedicated button of user interface 48) to send a “share” message 202 to mobile device 31B (see arrow 203) of user 30B. This message is, for example, sent via the wireless LAN 36 using the known addresses of mobile devices of members of the same party, these addresses having been previously stored in the visit data memory 43 of device 31A; alternatively, the device 31A may simply use a short-range communications means, such as a Bluetooth radio system, to send the message 202 to any device that is nearby (this approach, though less secure, is generally acceptable in an environment such as the exhibition hall 10 because the media object itself is not confidential). The message 202 includes both an identifier of the media object 200 currently being accessed by the mobile device 31A (for example, in the form of an item URI—Uniform Resource Indicator), and an indicator of the current position reached by the user 30A in consuming the streamed media object 200 (for example, frame number, time point, etc.).

It will first be assumed that the presentation of the media object 200 at the device 31A is not paused at the time the message 202 is sent.

The mobile device 31B on receiving the message 202 estimates an appropriate PRO advance value and then, with or without specific consent from the user 30B, sends a message 204 to the server 53 (arrow 205). The message 204, in addition to containing contact data for the device 31B, also contains the ID of the media object 200 and a predicted start position within the media object from where the server should start streaming the object to the device 31B for the latter to present the object to the user 30B substantially in coordination with the ongoing presentation of the object to the user 30A by the device 31A. The predicted start position is the current presentation position indicated by the position indicator in message 202 plus the estimated PRO advance. The PRO advance can comprise one or more of the following components:
a component taking account of the time needed to generate the message 202 and to send it from the mobile device 31A to the mobile device 31B (this can be a preset approximation);
a component talking account of the time between receipt of message 202 at device 31B and the time of receipt of message 204 by the server 53;
a component taking account of the time between the receipt of the message 204 by the server 53 and the initiation of streaming of the media object 200 to the device 31B; and
a component taking account of the time to transmission time of the media object data from the server 53 to the device 31B and the time delay before the device 31B starts presenting the received stream to the user 30B.

The PRO advance value can be omitted or can be estimated by the server 53 (in which case the position indicator contained in message 202 is forwarded to the server in message 204 instead of the predicted start position).

The message 204 is received by the interface unit 70 of the server 53 and triggers the instantiation of a stream delivery entity 72 (typically a software process) for streaming the media object 200 to the device 31B. The sending start position within the media object 200 is the predicted start position either contained in the message 204 or derived by the unit 70 on the basis of the information contained in the message 204. Once established, the entity 72 initiates streaming of the media object 200 to the device 31B starting at the predicted start position; the device 31B presents the received media-object stream (arrow 206) to the user 30B without delay.

Because the position indicator contained in message 202 relates to the current presentation position reached by the device 31A in presenting the streamed media object, and further because the start position used for the media stream 206 is based on that position indicator, whether or not the device 31A caches the media stream 201 is irrelevant to the operation of the FIG. 5 arrangement. It therefore does not matter whether or not the delivery rate of the media stream 201 exceeds its consumption rate.

At the time of sending the message 202 the user 30A may decide to pause the presentation of the media object 200 at the device 31A, this pause being to enable the user 30B to access the media object 200 at the earliest possible coordinated position for going forward from the first user's current position. In this case, the pausing of consumption at device 31A is indicated in the message 202 with the result that the PRO advance is set to zero so that the media-object stream 206 begins from the position indicated by the position indicator in message 202, that is, the paused presentation position of stream 201 at device 31A. As soon as the device 31B starts to receive the stream 206, it starts to present the media object 200 and simultaneously sends a restart message (not depicted in FIG. 5) to the device 31A to cause the latter to recommence consumption of stream 201. The device 31B can delay start of presentation of the stream 206 by an amount corresponding to the predicted time for the restart message to be sent and acted upon by the device 31A.

In fact, rather than the second device 31B starting presentation based on when it sends the restart message to the first device 31A, the second device 31B can be arranged to wait for a “go” message back from the first device 31A before starting. This enables the first device 31A to ensure that all devices which are to participate in coordinated consumption, are ready to do so before consumption begins (in other words, the device 31A waits to receive restart messages from all expected participating devices indicating they are ready to start presentation before it sends out the “go” signal).

It may be noted that provided the first device 31A has a cache for storing the stream 201, pausing the presentation of the stream does not require the sending of the stream to be paused though this can be done, for example, by sending a pause message 208 from the device 31A to the server 53 as indicated by dashed arrow 209 (in which case the sending of the stream 201 must be restarted in due course, for example by a message, not depicted in FIG. 5, sent from the device 31A to the entity 71 at the time that the device 31A recommences presentation of the stream 201).

A number of variants are possible to the FIG. 5 arrangement. For example, it is possible to arrange for the second mobile device(s) 31B to assume that the first device 31A will have paused the presentation of the media stream at the time of sending the message 202 (indeed, such a pause can be enforced at device 31A in coordination with sending of the message 202); in this case, the message 202 would not need to include a “pause” indication. If this is used as a default setting but continued consumption at the instigating device 31A is still permitted, then in cases where device 31A continue its consumption, this is preferably indicated in message 202 to permit the device 31B to add an appropriate advance as already discussed. In another variant, all control communication with the server 53 can be via the device 31A, the latter passing the server 53 contact data for contacting the device 31B as well as the information previously contained in message 204.

In another variant, in additional to the current presentation position reached in the media object 200 by device 31A being included in message 202, a more up-to-date version of this information can be passed to the device 31B in a message sent in response to device 31B indicating that it is starting to receive the media object stream 206 from server 53. This enables the device 31B to make adjustments regarding where in the stream 206 it should start presentation of the media object 200.

Considering next the arrangement illustrated in FIG. 6, this is similar to that of FIG. 5 except in the FIG. 6 arrangement the start position for streaming the media object 200 to the device 31A is based on the sending position reached for streaming the object from server 53 to the device 31A in stream 201 at the time that the server is asked to initiate streaming to the device 31B. As a result, an important factor in achieving coordinated consumption is the aforesaid R-P offset value (that is, the offset at device 31A between the current receiving and presentation positions in the stream 201).

More particularly, as in the FIG. 5 arrangement when the user 30A wishes to initiate coordinated consumption of media object 200 being streamed to it in stream 201, the user 30A causes message 202 to be sent, in any appropriate manner, to the device 31B of user 30B. However, in the FIG. 6 arrangement the message 202 comprises in addition to the URI of the media object 200, an identifier (ID) of the device 31A as known to the server 53 and the current value of the R-P offset at device 31A (this value will be zero if the stream 201 is only delivering the object 200 at a rate equivalent to the presentation rate as would be the case, for example, if the device 31A has no cache for the stream 201). The device 31B passes on the ID of device 31A and the R-P offset to the interface unit 70 of server 53 in message 204, along with the identity of the object 200 and contact data for device 31B.

The interface unit 70 instantiates a stream delivery entity 72 for streaming the object 200 to the device 31B. The entity 72 uses the ID of device 31A and the ID of the object 200 to determine from the stream delivery entity 71 (see arrow 210) the current sending position reached in object 200 for the stream 201. The entity 72 then starts to stream the media object 200 in stream 206 to the device 31B from a position in object 200 corresponding to the current sending position for stream 201 less the R-P offset specified in message 204; in the situation where the presentation of the object 200 to the user 30A at device 31A has not been paused, the P-R offset can be decreased to take account of run on of the presentation during the period from when the message 202 was generated and sent until the time the stream 206 starts to be received at the device 31B. Assuming the presentation at device 31A has not been paused, as soon as the device 31B starts to receive the stream 206, it presents it to the user 31B; this presentation will be substantially coordinated with the ongoing presentation of the media object 200 at device 31A.

If presentation of the media object at device 31A was paused when the message 202 was generated and sent, then the same approaches as described above with respect to the FIG. 5 arrangement can be used for restarting presentation at the device 31A. More particularly, when the device 31B starts receiving the stream 206 it sends a restart message to the device 31A and either immediately starts presenting the stream 206 (subject to a delay corresponding to the predicted time for the restart message to be sent and acted upon by the device 31A), or defers doing so until a “go” message is received back from the device 31A.

Where presentation at device 31A is paused at the time of sending the message 202, the FIG. 6 arrangement is arranged also to pause the sending of the stream 201 to the device 31A; this is effected by sending apause message 208 to the server 53 (see arrow 209). This is done in order to keep the actual offset between the receiving and presentation positions of the stream 201 at device 31A substantially equal to the R-P offset value included in the message 202. The sending of the stream 201 is restarted in due course, for example by a message (not depicted in FIG. 6) sent from the device 31A to the entity 71 at the time that the device 31A recommences presentation of the stream. In fact, it would be possible to allow sending of stream 201 to continue whilst presentation at device 31A is paused, provided that the entity 72 is arranged to increase the value of the R-P offset by an amount corresponding to the portion of the stream predicted to be sent between the pausing of presentation at device 31A and the start of receipt of the stream 206 by the device 31B.

Similar variants to those discussed above for the FIG. 5 arrangement are also possible in respect of the FIG. 6 arrangement. Thus, for example, the information contained in message 204 (including the contact data for device 31B) can be sent to the server 53 by the device 31A rather than the device 31B.

The FIG. 7 arrangement is similar to those of FIGS. 5 and 6 except that now the stream 201 being sent to the device 31A is, at the time that the user 30A decides to share the media object, effectively “split” into two streams one of which continues to form the stream 201 for the device 31A and the other of which forms the stream 206 for the device 31B. In other words, more than one copy of the same data stream from the media object 200 is created, one of which is sent by the entity 71 to the device 31A and the other of which is sent by the entity 72 to the device 31B. It may be noted that because generally there will be flow control mechanisms operating between the entity 71 and device 31A and between the entity 72 and the device 31B, the steams 201, and 206 will not necessarily be in synchronism and the entities 71 and 72 will typically include buffering downstream of the splitting of the single media-object into two streams in order to provide a degree of isolation between the flow control effected on streams 201 and 206. Without such buffering, flow control of either one of the streams 201, 206 would require corresponding control of the un-split media-object stream which would necessarily impact the other one of the streams 206, 201. Unless the buffering provided in entities 71 and 72 can cope with extremes in differences in the streaming of streams 201 and 206, then it will still be necessary to provide for the temporary pausing of the un-split stream should the buffering in entity 71 or 72 become full as a result of the flow control being effected on the corresponding stream 201, 206. thereby to isolate each of these streams from the flow control effected on the other stream

Considering the FIG. 7 arrangement in more detail, when the user 30A wishes to initiate coordinated consumption of media object 200 being streamed to it in stream 201, the user 30A causes message 202 to be sent, in any appropriate manner, to the device 31B of user 30B. The message 202 comprises in addition to the URI of the media object 200, an identifier (ID) of the device 31A as known to the server 53. The device 31B passes on the ID of device 31A to the interface unit 70 of server 53 in message 204, along with the identity of the object 200 and contact data for device 31B.

The interface unit 70 instantiates a stream delivery entity 72 for streaming the object 200 to the device 311B. The entity 72 copies the stream 201 to form stream 206 which it sends to the device 31B. Where the presentation of the stream 201 at device 31A has not been paused at the time the message 202 was sent, then in the case where the effective rate of sending of the stream 201 is equal to its rate of presentation (for example, in the situation where the device 31A does not cache the stream 201), the device 31B starts presentation of the stream 206 to the user 30B immediately the device 31B receives the stream 206 with the result that the users 30A and 30B are presented with the object 200 in synchronism. However, if the device has a cache and receives the stream 201 at a greater rate than its presentation rate, were the device 311B to start to present the stream 206 immediately upon receipt, this presentation of media object 200 would be in advance of the presentation of the object 200 at device 31A by an amount corresponding to the R-P offset for the device 31A. In order to overcome this problem, the sending position of the stream 201 is “jumped-back” to the presentation position for stream 201 at device 31A at the time the message 202 is sent, and the cache for stream 201 in device 31A is flushed. Jump-back of the stream sending position can be effected by including the presentation position for device 31A in message 202, this position being passed in message 204 to the interface unit 70 of server 53 which uses it to cause the stream sending entity 71 to “jump-back” its sending position for stream 201 (preferably, in order to avoid the user 30A experiencing a jump-back in what is being presented to the user, allowance should be made for the presentation run on in the period between when the message 202 was generated and when the jump-back effected at the server). Jump-back can alternatively be effected by the device 31A sending a jump-back message 208 (see arrow 209) to the server 53 although in this case the entity 71 should only send the jumped-back stream 201 at the presentation rate of the media object until the entity 72 and the stream 206 have been established (since otherwise an R-P offset could develop in device 31A before the device 311B is ready to start presenting the object 200).

If presentation of the media object at device 31A is paused when the message 202 is generated and sent, then the above-described jump-back approach is preferably used with the jump back being effected at the time the entity 72 is ready to start streaming and a cache-flush command being simultaneously sent to the device 31A. In this case, it does not matter whether the sending of the stream 201 is or is not paused whilst the presentation at device 31A is paused since either way both devices 31A and 311B will receive the same jumped back streams and be ready to present them from the paused presentation position of stream 201 when required. As regards the actual (re)starting of presentation at the devices 31A and 31B, the same approaches as described above with respect to the FIG. 6 arrangement can be used. More particularly, when the device 31B starts receiving the stream 206 it sends a restart message to the device 31A and either immediately starts presenting the stream 206 (subject to a delay corresponding to the predicted time for the restart message to be sent and acted upon by the device 31A), or defers doing so until a “go” message is received back from the device 31A. Of course, if the sending of stream 201 has been paused, the stream 206 will not commence until the stream 201 has been unpaused—in this case, the entity 72 can be arranged to send the device 31B an indication that it is ready to start streaming and this indication can be used as the trigger for the restart message; the device 31A, on receipt of the restart message (or on receipt of such messages from all expected participating devices) sends a message to the server to restart stream 201 and thus also start stream 206.

Similar variants to those discussed above for the FIG. 5 arrangement are also possible in respect of the FIG. 7 arrangement. Thus, for example, the information contained in message 204 (including contact data for device 31B) can be sent to the server 53 by the device 31A rather than the device 31B.

It will be appreciated that the arrangements of FIGS. 6 and 7 both work by coordinating the sending of the media object 200 from the server to the devices 31A and 31B when the stream 206 is first established. In particular, if there is no R-P offset at the device 31A then in the FIG. 6 arrangement the initial sending position is made the same as the then current sending position of stream 201; however, if there is an R-P offset, the coordination further involves modifying the initial start position of stream 206 by the R-P offset. The basic difference between the arrangements of FIGS. 6 and 7 is that in the FIG. 7 arrangement, an attempt is made to maintain at least a degree of coordination between the sending of the streams 201 and 206 on an on-going basis which is not the case for the FIG. 6 arrangement.

Of course, the arrangements of FIGS. 6 and 7 also differ in how they deal with any R-P offset—in the FIG. 6 arrangement, this is done by compensating for the R-P offset by applying a corresponding offset to the initial sending position for the stream 206, whereas in the FIG. 7 the R-P offset is eliminated by flushing the cache in device 31A, with a consequential resetting (“jump-back”) of the sending position of the stream 201 to the current presentation position at device 31A. In fact, these two approaches for dealing with the R-P offset (offset compensation, offset elimination) can be inter-changed. Thus, instead of using the R-P offset elimination approach, the FIG. 7 arrangement can be modified to use the R-P offset compensation approach—for example, the device 31A can be arranged to include its current R-P offset value in message 202 and the device 31B arranged to delay presenting the stream 206 by an amount corresponding to this offset. Conversely, instead of the FIG. 6 arrangement using the R-P offset compensation approach, the FIG. 6 arrangement can be modified to use the R-P offset elimination approach with the cache of device 31A being flushed and the sending position for stream 201 being reset (jumped-back) to the presentation position at device 31A—in this case, the initial sending position of the stream 206 is simply the jumped-back sending position for stream 201.

For any of the arrangements of FIGS. 5, 6 and 7, there can be a delay between the pausing of the stream 201 and the sending of the message 202—indeed, these two events can require separate respective acts of the user 30A. Furthermore, in any of the arrangements, the initiation of coordinated consumption can be triggered by the user 30B using device 31B rather than by user 30A using device 31A.

In addition, for any of the arrangements, one or both of the devices 31A and 31B can be arranged to send further coordination signals at any time during the course of the coordinated consumption of the media object 200 by the devices, in order to compensate for drift in consumption rates. Thus, for example, the device 31A as the instigating device, can be arranged to send periodic coordination signals to the device 31B which indicate the current position reached by the device 31A; the device 31B uses this information either to jump backwards/forwards in the stream it is receiving or to make appropriate adjustments to its rate of consumption of the media stream to return to synchronization with consumption by device 31A (for example, by the time the next coordination signal is expected to be received).

As well as the sending of periodic coordination signals, one or both of the devices 31A, 31B can be arranged to send change signals in correspondence to its own changes in position in the media stream (other than resulting from normal progression therethrough) and/or changes in its own progression mode through the media stream (such as, without limitation, rewind and fast forward), these change signals including an indication of the new position/progression mode to be adopted by the receiving device.

Whilst coordinated consumption could be effected in the above-described manner for static devices separate by large distances, it is expected that the above-described methods are most suitable where at least one of the devices is a mobile one and the devices have been brought into close proximity.

It will be appreciated that many other variants are possible to the above described arrangements. For example, and as already noted, the distribution of functionality between mobile devices and the service system is not limited to the distributions described above since the availability of communication resources makes it possible to place functionality where most suitable from technical and commercial considerations. Furthermore, in the foregoing reference to a mobile device is not to be construed as requiring functionality housed in a single unit and the functionality associated with a mobile device can be provided by a local aggregation of units.

It will be appreciated that the above described methods and arrangements for coordinating the consumption of streamed media objects are not limited to situations where the media objects are associated with a currently visited space.

1. A method of establishing coordinated consumption of a streamed media object by first and second devices, comprising the steps of:
(a) in the course of streaming the media object in a first stream from a server to the first device and presenting the object thereat, using a said device to effect initiation of said coordinated consumption;
(b) consequent on said initiation, establishing streaming of the media object from the server to the second device in a second stream separate from said first stream and starting from a position in the media object that is dependent on progress of the streaming/presentation of the object to/at the first device; and
(c) presenting the media object at the second device.

2. A method according to claim 1, wherein in step (b) the said position at which the second stream is started is dependent on the position reached in presenting the media object to the first device at the time of said initiation.

3. A method according to claim 2, wherein:
presentation of the media object at the first device continues whilst the second stream is established;
the position at which the second stream is started is the said position reached in presenting the media object to the first device at the time of said initiation, adjusted by an amount that takes account of run on of the presentation of the media object at the first device during establishment of the second stream; and
in step (c) presentation of the media object at the second device commences substantially upon receipt of the second stream by the second device.

4. A method according to claim 2, wherein:
presentation of the media object at the first device is paused at least whilst the second stream is established;
the position at which the second stream is started is substantially the said position reached in presenting the media object to the first device at the time of said initiation; and
in step (c) presentation of the media object at the first device is restarted substantially at the same time as presentation of the media object at the second device is started.

5. A method according to claim 4, wherein the second device sends the first device a commencement signal in coordination with starting presentation of the media object at the second device, presentation of the media object at the first device being restarted in response to receipt of said commencement signal at the first device.

6. A method according to claim 4, wherein in step (c) the second device sends a ready-to-commence indication to the first device when it is ready to commence presentation of the media object; the first device, following receipt of said ready-to-commence indication, sending a commencement signal to the second device and restarting presentation of the media object at the first device in coordination with the sending of the commencement signal; and the second device starting presentation of the media object at the second device upon receipt of the commencement signal.

7. A method according to claim 1, wherein in step (b) the said position at which the second stream is started is dependent on the then current position reached in sending the media object from the server to the first device.

8. A method according to claim 7, wherein the streamed media object is presented at the first device as soon as it is received in the first stream, the said position at which the second stream is started in step (b) being the then current position reached in sending the media object from the server to the first device.

9. A method according to claim 7, wherein:
the first device includes a cache used to hold any portion of the media object received in the first stream but yet to be presented; and
in step (b) the said position at which the second stream is started is the then current position reached in sending the media object from the server to the first device less an offset corresponding to any offset at the first device between receiving and presentation positions in the media object.

10. A method according to claim 7, wherein:
the first device includes a cache used to hold any portion of the media object received in the first stream but yet to be presented;
in step (b) the said position at which the second stream is started is the then current position reached in sending the media object from the server to the first device; and
the second device delays the start of presentation of the media object in step (c) by an amount corresponding to any offset at the first device between receiving and presentation positions in the media object.

11. A method according to claim 7, wherein:
the first device includes a cache used to hold any portion of the media object received in the first stream but yet to be presented;
in step (b) the position reached in sending the media object from the server to the first device in the first stream is jumped back by an amount corresponding to any offset at the first device between receiving and presentation positions in the media object, the said position at which the second stream is started being made substantially the jumped-back sending position of the first stream; and
the cache of the first device is flushed subsequent to said initiation of coordinated consumption but no later than commencement of presentation of the media object at the second device in step (c).

12. A method according to claim 7, wherein presentation of the media object at the first device continues whilst the second stream is established, presentation of the media object at the second device in step (c) commencing substantially upon receipt of the second stream by the second device.

13. A method according to claim 7, wherein presentation of the media object at the first device is paused at least whilst the second stream is established, presentation of the media object at the first device being restarted in step (c) substantially at the same time as presentation of the media object at the second device is started.

14. A method according to claim 13, wherein the second device sends the first device a commencement signal in coordination with starting presentation of the media object at the second device, presentation of the media object at the first device being restarted in response to receipt of said commencement signal at the first device.

15. A method according to claim 13, wherein in step (c) the second device sends a ready-to-commence indication to the first device when it is ready to commence presentation of the media object; the first device, following receipt of said ready-to-commence indication, sending a commencement signal to the second device and restarting presentation of the media object at the first device in coordination with the sending of the commencement signal; and the second device starting presentation of the media object at the second device upon receipt of the commencement signal.

16. A method according to claim 7, wherein after establishment of the second stream, the generation and sending of the first and second streams is carried out independently.

17. A method according to claim 7, wherein at the server an internal stream is formed from the media object and processed for sending as said first stream, the internal stream being duplicated and processed for sending as said second stream.

18. A method according to claim 1, wherein subsequent to the commencement of presentation of the media object by both the first and second devices in at least approximate coordination, presentation coordination signals are periodically sent from at least one device to the other to enable the latter to adjust its presentation of the media object to bring it into closer coordination with the presentation by said one device.

19. A method according to claim 1, wherein subsequent to the commencement of presentation of the media object by both the first and second devices in at least approximate coordination, a change signal is sent from at least one device to the other upon the said one device changing its presentation position in or progression through the media object otherwise than as part of its normal progression therethrough, the said other device using this change signal to adjust its presentation of the media object correspondingly.

20. A method according to claim 1, wherein the first and second devices are mobile devices.

21. A server for use in establishing coordinated consumption of a streamed media object by first and second devices, the server comprising:
a first entity for streaming the media object to the first device in a first stream;
a second entity for streaming the media object to the second device in a second stream separate from said first stream; and
a control arrangement arranged to receive an indication, in the course of the first entity streaming the media object to the first device in said first stream, that coordinated consumption of the media object by the first and second devices is to be established;
the control arrangement being further arranged, in response to receipt of said indication, to cause the second entity to establish streaming of the media object to the second device in said second stream starting from a position in the media object that is dependent on progress of the streaming/presentation of the object to/at the first device.

22. A server according to claim 21, wherein the control arrangement is further arranged to receive from a said device a presentation-position indicator indicative of a position reached in presenting the media object to the first device at the time said indication is provided, the second entity being arranged to start said second stream at a position dependent on the position indicated by said presentation-position indicator.

23. A server according to claim 22, wherein the second entity is arranged to start the second stream at the position indicated by said presentation-position indicator adjusted by an amount corresponding to a predicted run on of the presentation of the media object at the first device during establishment of the second stream.

24. A server according to claim 22, wherein the second entity is arranged to start the second stream substantially at the position indicated by said presentation-position indicator.

25. A server according to claim 21, wherein the second entity is arranged to start said second stream at a position dependent on the then current position reached by the first entity in sending the media object from the server to the first device in said first stream.

26. A server according to claim 25, wherein the said position at which the second stream is started is substantially the said then current position reached by the first entity in sending the media object from the server to the first device.

27. A server according to claim 25, wherein the control arrangement is further arranged to receive from a said device a reception-presentation offset indicator indicative of any offset at the first device between receiving and presentation positions in the media object, the second entity being arranged to start the second stream at a position corresponding to the then current position reached in sending the media object from the server to the first device less an offset corresponding to the offset, if any, indicated by said reception-presentation offset indicator.

28. A server according to claim 25, wherein the control arrangement is further arranged to receive from a said device a jump-back indicator that is indicative of any offset at the first device between receiving and presentation positions in the media object; the control arrangement being arranged to respond to receipt of said jump-back indicator by causing the first entity to jump back its sending position for the first stream by an amount corresponding to any offset indicated by said jump-back indicator; and the second entity being arranged to start the second stream at a position corresponding to the sending position of the first stream after it has been jumped back.

29. A server according to claim 25, wherein the first and second entities are so arranged that after establishment of the second stream, the generation and sending of the first and second streams is carried out independently.

30. A server according to claim 25, wherein the server is arranged to form an internal stream from the media object and the first entity is arranged to process this internal stream for sending as said first stream, the control arrangement being arranged to duplicate said the internal stream in response to receipt of said indication with the second entity being arranged to process the duplicate stream for sending as said second stream.

31. A method of coordinated consumption of a streamed media object by first and second devices, the media object being accessible for streaming from a server, the method comprising the steps of:
(a) streaming the media object from the server to the first device and presenting it to a user of this device;
(b) sending from the first device to the second device, during the course of step (a), data identifying the media object and a current position reached in presenting the object to the user of the first device;
(c) in response to a request from the second device, streaming the media object from the server to the second device in a separate stream to that involving the first device with the second stream starting from a position in the media object that is at or near the current position reached by the first device in presenting the media object; and
(d) presenting the media object to the user of the second device such that normal presentation commences at a position at, or with an advance relative to, the said current position indicated in step (b).
